(19) United States
(12) Patent Application Publication
(10) Pub. No.: US 2007/0021904 A1
(43) Pub. Date: Jan. 25, 2007

(54) Travel assistance device for vehicle

(75) Inventors: Shiyouta Kawamata, Hiroshima (JP); Haruhisa Kore, Hiroshima (JP)

Correspondence Address: NIXON PEABODY, LLP, 401 9TH STREET, NW, SUITE 900, WASHINGTON, DC, 20004-2128, US

(73) Assignee: MAZDA MOTOR CORPORATION, Hiroshima (JP)

(21) Appl. No.: 11/488,726

(22) Filed: Jul. 19, 2006

(30) Foreign Application Priority Data
Jul. 25, 2005 (JP) 2005-214232

(51) Int. Cl. G01C 21/00

(52) U.S. Cl. 701/200

(57) ABSTRACT

The relative position of the surrounding vehicle to the traveling vehicle is determined from respective position information of the traveling vehicle and the surrounding-vehicle obtained through communication between vehicles. The processing area of the image picked up by the camera is restricted on the basis of this relative position. By comparing the template that is obtained with a scale-transfer from the previously-memorized template on the basis of the position information of the vehicle to the image of the vehicle with an image matching, the precious position of the surrounding vehicle is detected. Thereby, the passenger protection devices are operated. Accordingly, the processing time of image data picked up by the camera can be properly shortened and the accuracy of recognition of obstacles can be improved.

### BACKGROUND OF THE INVENTION

The present invention relates to a travel assistance device for a vehicle that can properly assist recognition, judgment and operation of a driver by detecting surrounding obstacles and thereby reduce troubles in a vehicle traveling.

Conventionally, a travel assistance device for a vehicle is known, which can assist driver's recognition, judgment and operation so as to avoid crashes with any obstacles, such as other vehicles, existing in surroundings of the traveling vehicle, by using communication between vehicles and a camera, such as CCD camera or CMOS camera, to pick up images and detect such obstacles. For example, Japanese Patent Application Laid-Open Nos. 2001-283381 or 2000-68923 disclose a technology in which existing obstacles on a traveling road can be recognized on the basis of image data of surroundings picked up by the camera of the traveling vehicle and information obtained through communication between vehicles. Also, Japanese Patent Application Laid-Open No. 2005-5978 discloses a technology in which an existing area of obstacles is estimated on the basis of image data of the camera and data from the communication between vehicles.

Herein, there is a certain problem. Namely, in order to detect the obstacles by processing the image data of surroundings that are captured by the camera of the traveling vehicle as described above, the traveling vehicle generally needs to in advance prepare for some data base with respect to generalized characteristics of the surrounding vehicles and then to compare the data base with the image data picked up for the recognition of the obstacles. Accordingly, in a case where such data base contains lots of information, processing image data would require a long time. Meanwhile, in a case where information of data base is too few, accuracy of recognition of obstacles would deteriorate.

### SUMMARY OF THE INVENTION

The present invention has been devised in view of the above-described problem, and an object of the present invention is to provide a travel assistance device for a vehicle that can properly shorten a processing time of image data picked up by the camera and improve accuracy of the recognition of obstacles.

According to the present invention, there is provided a travel assistance device for a vehicle, comprising a camera operative to pick up an image of surroundings of a traveling vehicle, a position detecting device operative to detect a position of the traveling vehicle, a signal receiving device operative to receive a signal from other vehicles than the traveling vehicle through communication between vehicles, a position relationship determining device operative to determine a position relationship between the traveling vehicle and the other vehicles on the basis of the position of the traveling vehicle detected by the position detecting device and data with respect to a position of the other vehicles that is contained in the signal received by the signal receiving device, a surrounding vehicle estimating device operative to estimate characteristics of the other vehicles that appear in the image picked up by the camera on the basis of data with respect to a feature of the other vehicles that is contained in the signal received by the signal receiving device and the position relationship determined by the position relationship determining device, and a vehicle identifying device operative to identify a specified vehicle among others that appear in the image picked up by the camera on the basis of the vehicle's characteristics estimated by the surrounding vehicle estimation device.

According to the present invention, since a specified vehicle is identified among others on the basis of the vehicle's characteristics estimated with the data with respect to the feature of other vehicles obtained through the communication between vehicles and the position relationship between the traveling vehicle and other vehicles, it may be unnecessary that the traveling vehicle in advance prepares for some data base with respect to surrounding vehicles and then compares such data base to the image picked up for identifying the specified vehicle among others, so a time for processing the image can be shortened properly. Also, since detailed data with respect to the feature of the surrounding vehicles can be obtained through the communication between vehicles, an accurate detection of the surrounding vehicles can be provided.

According to an embodiment of the present invention, there is further provided an image-area restricting device operative to restrict an area of the image for identification by the vehicle identifying device on the basis of the position relationship determined by the position relationship determining device. Thereby, since the area of the image for the identification is restricted on the basis of the position relationship between the traveling vehicle and other surrounding vehicles, the image area to be processed can be narrowed and thereby the processing time can be shorted properly.

According to another embodiment of the present invention, there is further provided a vehicle-crash possibility estimating device operative to estimate a possibility of a crash between the traveling vehicle and the vehicle specified by the vehicle identifying device. Thereby, since the possibility of the crash with the specified vehicle identified in the image is estimated, an accurate prediction of the crash with surrounding vehicles can be provided.

According to another embodiment of the present invention, the vehicle-crash possibility estimating device is configured to estimate the possibility of the crash on the basis of respective histories with respect to a traveling speed and a traveling direction of the traveling vehicle and the vehicle specified by the vehicle identifying device. Thereby, since the possibility of the crash is estimated on the basis of the respective histories with respect to the traveling speed and direction of the traveling vehicle and other surrounding vehicles, the accuracy of the crash prediction can be further improved by predicting traveling paths of the traveling vehicle and other surrounding vehicles.

According to another embodiment of the present invention, the vehicle-crash possibility estimating device is configured to also estimate a hitting portion and angle at the crash, and there is provided a passenger protection device to operate on the basis of the hitting portion and angle estimated by the vehicle-crash possibility estimating device so as to protect a passenger of the traveling vehicle. Thereby, since the hitting portion and angle at the crash are also estimated and the passenger is protected according to these estimated portion and angle, a proper operation of the passenger protection device can be provided.

Other features, aspects, and advantages of the present invention will become apparent from the following description which refers to the accompanying drawings.

### BRIEF DESCRIPTION OF THE DRAWINGS

FIG. 1 is a layout diagram of parts of a vehicle assistance device for a vehicle according to a preferred embodiment of the present invention.

FIG. 2 is a control system diagram of a control unit and others of the vehicle assistance device for a vehicle.

FIG. 3 is a flowchart of an exemplified control operation of the vehicle assistance device for a vehicle.

FIG. 4 is an explanatory diagram of an image of surrounding vehicles that is picked up by a camera.

FIG. 5 is an explanatory diagram showing restriction of an image-processing area in the picked-up image.

FIG. 6 is a plan view showing a position relationship between a traveling vehicle and a surrounding vehicle in front of the traveling vehicle in a vehicle width direction and a vehicle traveling direction.

FIG. 7 is an explanatory diagram showing a vehicle width and a central position of the surrounding vehicle in the picked-up image.

FIG. 8 is a side view showing the position relationship between the traveling vehicle and the surrounding vehicle in front of the traveling vehicle in a vehicle height direction and the vehicle traveling direction.

FIG. 9 is an explanatory diagram showing a vertical-direction position of the surrounding vehicle in the picked-up image.

FIG. 10 is an explanatory diagram showing a template of the surrounding vehicle that is estimated on the basis of the vehicle width, the central position and the vertical-direction position of the surrounding vehicle in the picked-up image.

FIG. 11 is an explanatory diagram showing a scale transfer of the template of the surrounding vehicle.

### DETAILED DESCRIPTION OF THE INVENTION

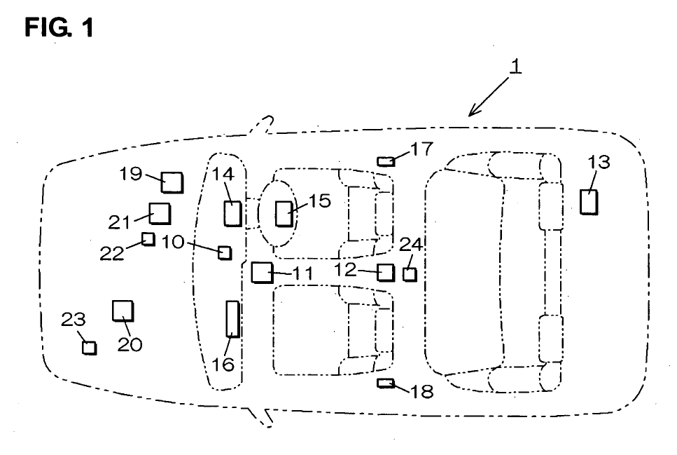

Hereinafter, a preferred embodiment of the present invention will be described referring to the accompanying drawings. FIG. 1 is a layout diagram of parts of a vehicle assistance device for a vehicle 1 according to the present embodiment. The vehicle assistance device 1 comprises a camera 11, such as a CCD camera or a CMOS camera, that is provided near a room mirror. The camera 11 picks up an image of surroundings of a traveling vehicle to identify obstacles from image data.

Also, the vehicle assistance device 1 comprises an antenna 12 for communication between vehicles as a signal receiving device that is provided at an upper portion, for example, a roof portion. This antenna 12 receives or sends signals from or to other vehicles that exit around the traveling vehicle through communication between vehicles. Herein, the signals sent from the surrounding vehicles contain vehicle information with respect to vehicle's position, model kind, size, feature, body color and so on.

Further, the vehicle assistance device 1 comprises a position-detecting antenna 13 as a position detecting device that is provided at a vehicle rear portion. This antenna 13 detects a position of the traveling vehicle on the earth by receiving signals from artificial satellites.

And, the vehicle assistance device 1 comprises an indication and warning device 14 that is provided at a vehicle front portion, for example, an instrument panel of the vehicle. This device 14 indicates obstacles, such as surrounding vehicles or pedestrians, that are detected by the camera 11, and warns a driver of necessity of avoiding crash or hitting with such obstacles with a visual or sound alarm.

The vehicle assistance device 1 further comprises a driver's-seat airbag 15, an assistant's-seat airbag 16, a driver's-seat seatbelt pre-tensioner 17 and an assistant's-seat seatbelt pre-tensioner 18, as a passenger protection device. The driver's-seat airbag 15 is installed in a steering wheel and the assistant's-seat airbag 16 is installed in a portion above a glove compartment. The seatbelt pre-tensioners 17, 18 operate to wind up respective seatbelts to protect the passengers when the possibility of the traveling vehicle crashing or hitting against the obstacles has increased.

The vehicle assistance device 1 comprises a brake-control actuator 19, a throttle-control actuator 20 and a steering-control actuator 21, as a vehicle control device for avoiding crash or hitting. These actuators 19-21 operate to avoid the crash or hitting with the obstacles or reduce impact of crash or hitting to assist the driver's driving the vehicle when the possibility of the traveling vehicle crashing or hitting against the obstacles has increased.

Also, the vehicle assistance device 1 comprises a steering angle sensor 22, a vehicle speed sensor 23 and a gyro sensor 24 (not illustrated), as a travel-state detecting device. These sensors 22, 23 and 24 detect a vehicle speed, a steering angle and a travel direction of the traveling vehicle, respectively, so the travel sate of the traveling vehicle is detected.

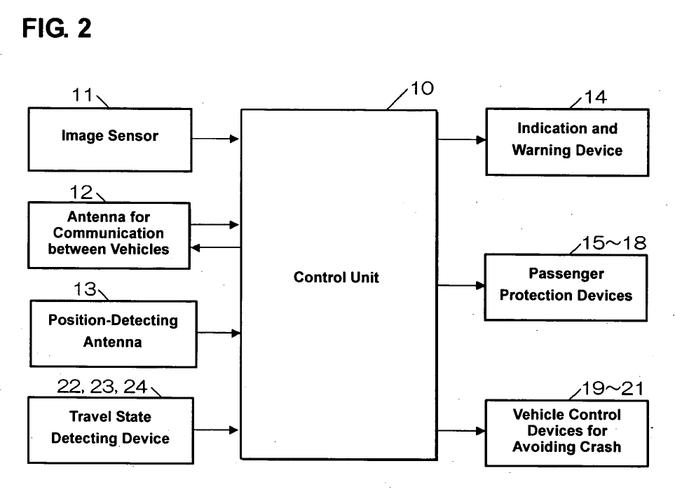

FIG. 2 is a control system diagram of a control unit 10 and others of the vehicle assistance device 1. The control unit 10 receives respective signals of the camera 11, antenna 12 for communication between vehicles, position-detecting antenna 13 and respective signals of the sensors 22-24, and outputs control signals to the indication and warning device 14, passenger protection devices 15-18 and vehicle control devices 19-21. The control unit 10 also sends information with respect to the traveling vehicle to the surrounding vehicles via the antenna 12 for communication between vehicles.

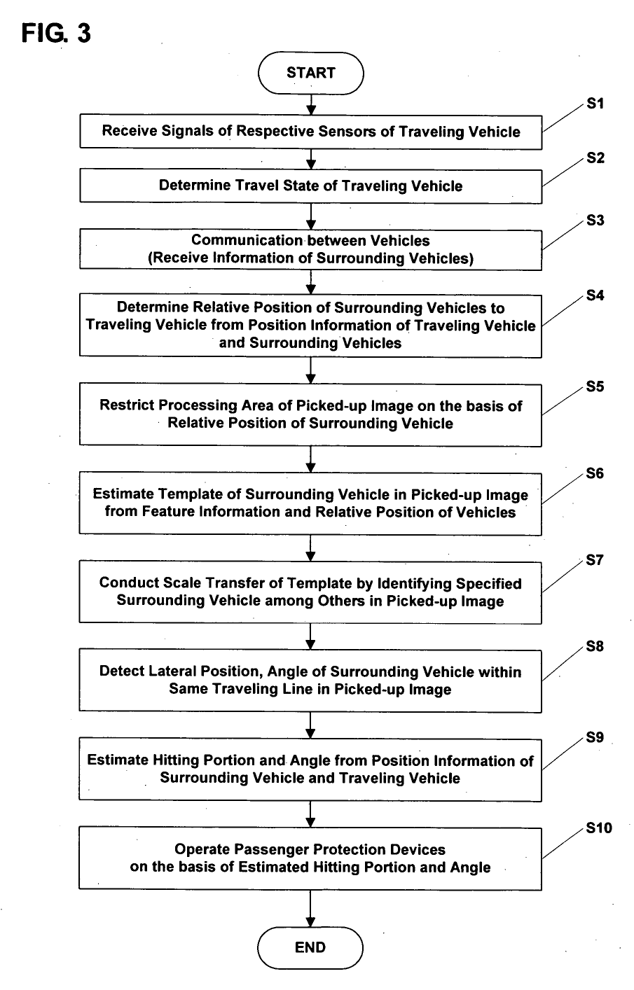

Next, an example of specific operations by the control unit 10 will be described referring to a flowchart of FIG. 3. First, respective signals of the sensors are received in step S1, and in step S2 the travel state of the traveling vehicle (position, traveling direction and so on) is determined. Then, in step S3, the information of the surrounding vehicles (position information, feature information) are obtained through the communication between vehicles.

Then, in step S4, the relative position of the surrounding vehicles to the traveling vehicle is determined from respective position information of the traveling vehicle and the surrounding vehicles obtained through the communication between vehicles. In step S5, the processing area of the image picked up by the camera 11 is restricted on the basis of the relative position of the surrounding vehicles. Then, in step S6, a template of the surrounding vehicle in the picked-up image is estimated on the basis of the feature information and the relative position of the vehicle. And, in step S7, a scale transfer of the template is conducted by identifying a specified surrounding vehicle among others in the picked-up image.

Subsequently, in step S8, a lateral position and an angle of the surrounding vehicle within the same traveling line are detected. Then, in step S9, a hitting portion and angle of the traveling vehicle against the surrounding vehicle at the possible crash are estimated on the basis of the respective position information of the traveling vehicle and the surrounding vehicle. In step S10, the indication and warning device 14 and the passenger protection devices 15-18 are operated on the basis of the estimated hitting portion and angle. Then, a control sequence ends.

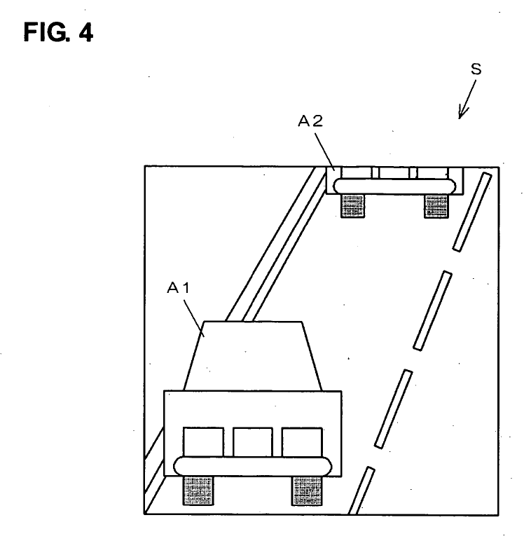

FIG. 4 shows an image S of surrounding that is picked up by the camera 11. In the picked-up image S, a surrounding vehicle A1 travels in front of the traveling vehicle (not illustrated) in the same traveling line, and another surrounding vehicle A2 travels ahead of the vehicle A1.

Herein, the above-described controls by the steps 1-4 of FIG. 3 are executed. Namely, the traveling state of the traveling vehicle, namely, various information of the traveling vehicle, such as the vehicle speed and the position, are determined based on information received from the sensors. Subsequently, information of the surrounding vehicles A1, A2, which are potential vehicles to crash against the traveling vehicle, such as the position information and the feature information of the surrounding vehicles, are received through the communication between vehicles. Thereby, respective relative positions of the traveling vehicle to the surrounding vehicles A1, A2 are determined on the basis -of the respective position information of the traveling vehicle and the surrounding vehicles A1, A2. Herein, the relative positions to the vehicles A1, A2 can be obtained from their positions (latitude and longitude) on the earth that are obtained from the position detecting antenna 13 and a traveling direction from their gyro sensor 24 that is obtained through the communication between vehicles, comparing to the traveling vehicle's information of the. position, traveling direction, steering angle and so on.

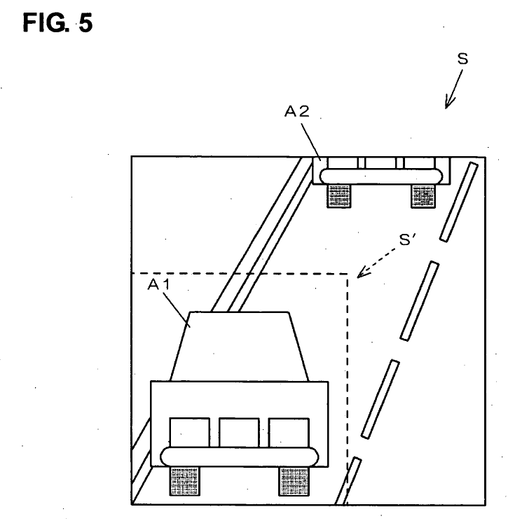

FIG. 5 shows a state of restriction of an image-processing area S′ including the vehicle A1 that is most likely to crash with the traveling vehicle in the picked-up image S, which corresponds to the step S5 of the flowchart of FIG. 3. After the restriction of the image-processing area S′, the controls by the steps S6 and S7 are executed. Namely, characteristics of the surrounding vehicle A1. in the image-processing area S′ are estimated based on the feature information and the relative position of the surrounding vehicle A1, namely the template of the surrounding vehicle A1 is estimated.

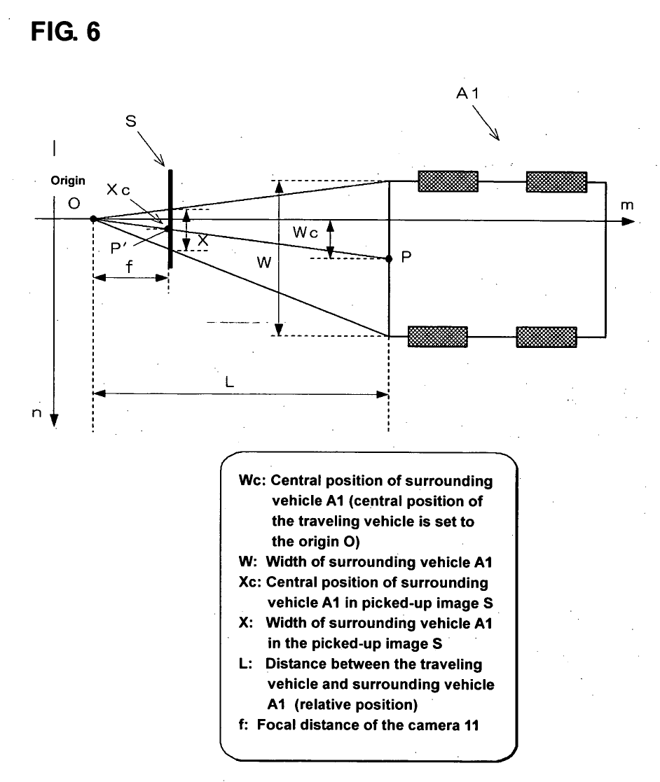

Herein, the way of estimating the template, i.e., characteristics, of the surrounding vehicle A1 in the picked-up image S will be described. FIG. 6 is a plan view showing the position relationship between the traveling vehicle and the surrounding vehicle A1 traveling ahead. In FIG. 6, the central position of the traveling vehicle is shown by the origin O, the traveling direction of the respective vehicles is shown by an axis m, the vehicle width direction of these vehicles is shown by an axis n, a length from a point p showing a central position of the vehicle A1 in the vehicle width direction to the axis m, namely the point p in the axis n, is shown by Wc, the width of the vehicle A is shown by W, and a length from a point p′ showing a central position of the vehicle A1 in the picked-up image S to the axis m, namely the point p′ in the axis n, is shown by Xc. Also, the width of the vehicle A1 in the picked-up image S is shown by X, a distance between the traveling vehicle and the vehicle A1, namely the relative position, is shown by L, and a point of the picked-up image S in the axis m, namely a focal distance is shown by f.

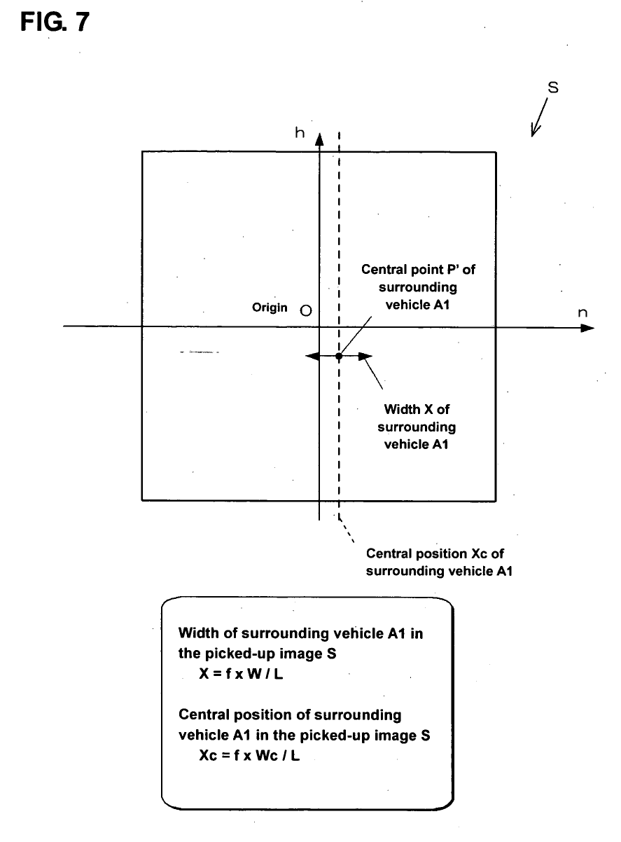

FIG. 7 shows the width X and the central position Xc of the surrounding vehicle A1 in the picked-up image S (an axis h shows a height direction in the picked-up image S which will be described below). Herein, the width X of the vehicle A1 in the picked up image S is obtained from the actual vehicle width W of the vehicle A1 and the vehicle distance L with calculation of an equation: X=f×W/L. The central position Xc of the vehicle A1 in the picked-up image S is obtained with an equation: Xc=f×Wc/L.

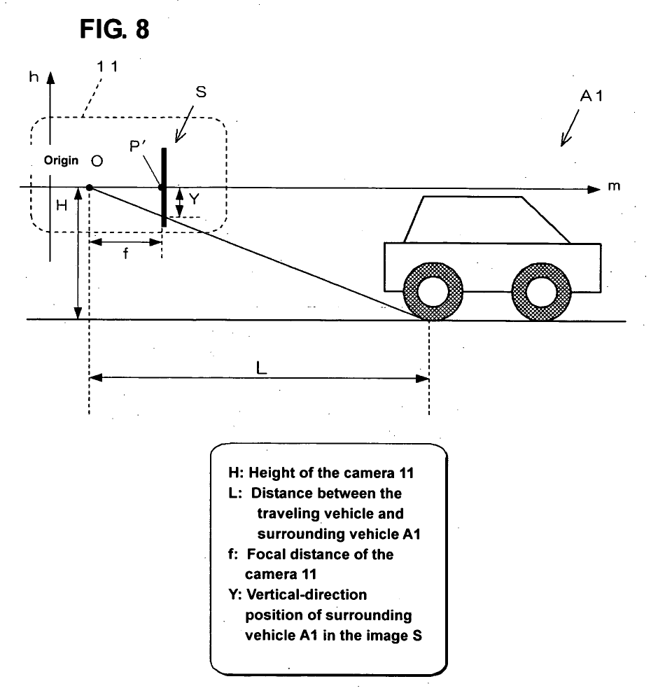

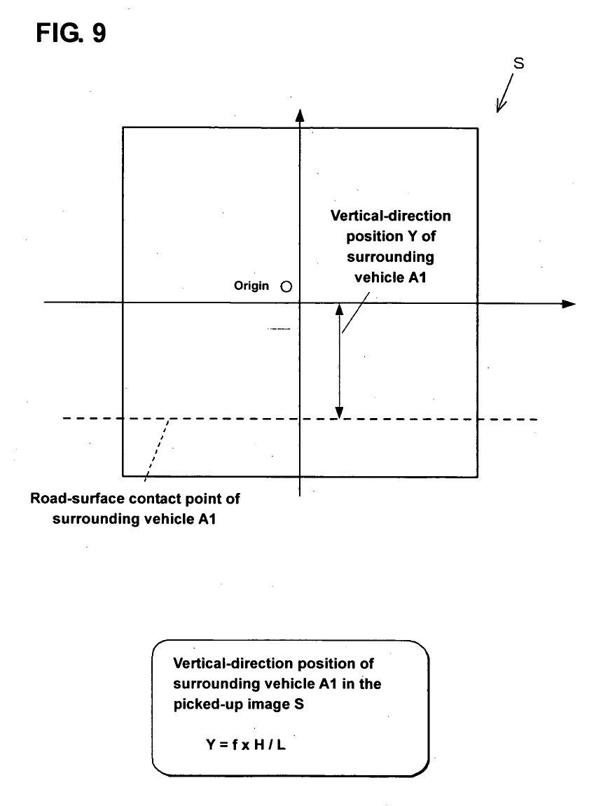

FIG. 8 is a side view showing the position relationship between the traveling vehicle and the surrounding vehicle A1. In FIG. 8, like FIG. 6, the central position of the traveling vehicle is shown by the origin O, the traveling direction of the respective vehicles is shown by the axis m, a direction perpendicular to the vehicle width direction of these vehicles is shown by an axis h, the distance between the traveling vehicle and the vehicle A1, namely the relative position, is shown by L, the point of the picked-up image S in the axis m, namely the focal distance is shown by f, a disposition height of the camera 11 of the traveling vehicle is shown by H, and a vertical-direction position of the vehicle A1 in the picked-up image S is shown by Y. FIG. 9 shows the vertical-direction position Y of the vehicle A1 in the picked-up image S, and the vertical-direction position Y is obtained from the distance L and the focal distance f with calculation of an equation: Y=f×H/L.

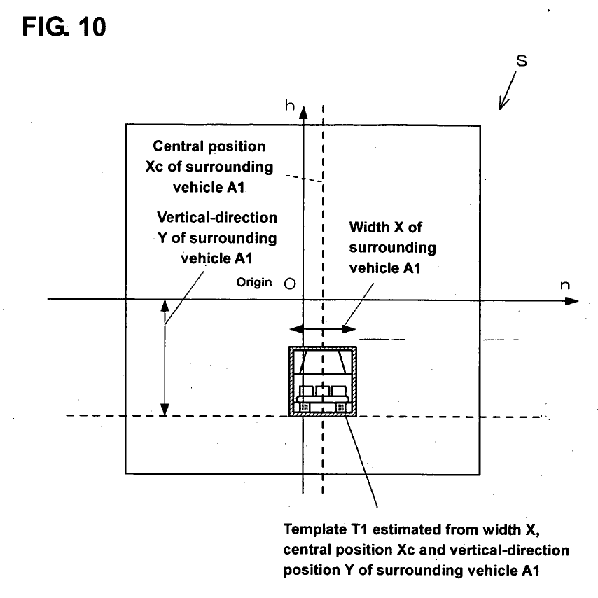

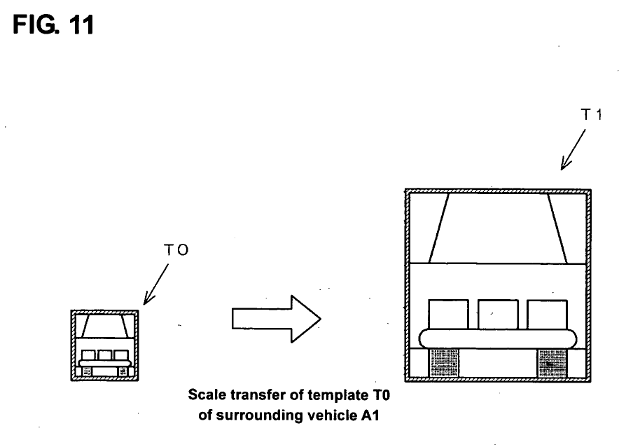

FIG. 10 shows a template T1 of the surrounding vehicle A1 that is estimated on the basis of the vehicle width X, the central position Xc and the vertical-direction position Y of the surrounding vehicle A1 in the picked-up image S. FIG. 11 shows the template T1 that is obtained with a scale-transfer from a previously-memorized template T0 on the basis of the position information of the vehicle A1. By comparing the template T1 to the image of the vehicle A1 captured by the camera 11 with an image matching, the precious position of the surrounding vehicle A1 is detected.

After this, controls of steps S8-10 in FIG. 3 are executed. Namely, the lateral position and the angle of the surrounding vehicle A1 in the traveling line estimated from the picked-up image S of FIG. 5, and the hitting portion and angle of the vehicles- are estimated. Then, the passenger protection devices 15-18 are operated on the basis of the estimated hitting portion and angle, thereby securing the safety of the passenger of the traveling vehicle.

Herein, although the hitting portion and angle of the vehicles are estimated on the basis of the respective position information of the traveling vehicle and the surrounding vehicle A1 in the step S9 of FIG. 3 in the present embodiment, they may be estimated on the basis of respective histories with respect to the traveling speed and the traveling direction of the traveling vehicle and the surrounding vehicle A1.

As described above, since the surrounding vehicle A1 is identified among others in the picked-up image S on the basis of the vehicle's template T1 estimated with the data with respect to the feature of the vehicle A1 obtained through the communication between vehicles and the position relationship between the traveling vehicle and the vehicle A1, it may be unnecessary that the traveling vehicle in advance prepares for some data base with respect to surrounding vehicle A1 and then compares the data base with the picked-up image S for identifying the specified vehicle A1 among others, so a time for processing the image can be shortened properly. Also, since detailed data with respect to the feature of the surrounding vehicle A1 can be obtained through the communication between vehicles, an accurate detection of the surrounding vehicle A1 can be provided.

Also, since the certain area S′ for identifying the vehicle A1 in the picked-up image S is restricted on the basis of the position relationship between the traveling vehicle and the surrounding vehicle A1, the image area to be processed in the picked-up image S can be narrowed and thereby the processing time to identify the vehicle A1 can be shorted properly.

Further, since the possibility of the crash with the vehicle A1 identified in the image S is estimated, an accurate prediction of the crash with surrounding vehicle A1 can be provided.

Especially, since the possibility of the crash is estimated on the basis of the respective histories with respect to the traveling speed and direction of the traveling vehicle and the surrounding vehicle A1, the accuracy of the crash prediction can be further improved by predicting traveling paths of the traveling vehicle and the surrounding vehicle A1.

And, since the hitting portion and angle. at the crash are also estimated and the passenger is protected according to these estimated portion and angle, a proper operation of the passenger protection devices 15-18 can be provided and thereby the safety of the passenger can be secured.

The present invention should not limited to the above-described embodiment, and any other modifications and improvements may be applied within the scope of a sprit of the present invention.

What is claimed is:

1. A travel assistance device for a vehicle, comprising:
a camera operative to pick up an image of surroundings of a traveling vehicle;
a position detecting device operative to detect a position of the traveling vehicle;
a signal receiving device operative to receive a signal from other vehicles than the traveling vehicle through communication between vehicles;
a position relationship determining device operative to determine a position relationship between the traveling vehicle and the other vehicles on the basis of the position of the traveling vehicle detected by said position detecting device and data with respect to a position of the other vehicles that is contained in the signal received by said signal receiving device;
a surrounding vehicle estimating device operative to estimate characteristics of the other vehicles that appear in the image picked up by said camera on the basis of data with respect to a feature of the other vehicles that is contained in the signal received by said signal receiving device and the position relationship determined by said position relationship determining device; and
a vehicle identifying device operative to identify a specified vehicle among others that appear in the image picked up by said camera on the basis of the vehicle's characteristics estimated by said surrounding vehicle estimation device.

2. The travel assistance device for a vehicle of claim 1, further comprising an image-area restricting device operative to restrict an area of the image for identification by said vehicle identifying device on the basis of the position relationship determined by said position relationship determining device.

3. The travel assistance device for a vehicle of claim 1, further comprising a vehicle-crash possibility estimating device operative to estimate a possibility of a crash between the traveling vehicle and the vehicle specified by said vehicle identifying device.

4. The travel assistance device for a vehicle of claim 3, wherein said vehicle-crash possibility estimating device is configured to estimate the possibility of the crash on the basis of respective histories with respect to a traveling speed and a traveling direction of the traveling vehicle and the vehicle specified by said vehicle identifying device.

5. The travel assistance device for a vehicle of claim 3, wherein said vehicle-crash possibility estimating device is configured to also estimate a hitting portion and angle at the crash, and there is provided a passenger protection device to operate on the basis of the hitting portion and angle estimated by the vehicle-crash possibility estimating device so as to protect a passenger of the traveling vehicle.

6. The travel assistance device for a vehicle of claim 4, wherein said vehicle-crash possibility estimating device is configured to also estimate a hitting portion and angle at the crash, and there is provided a passenger protection device to operate on the basis of the hitting portion and angle estimated by the vehicle-crash possibility estimating device so as to protect a passenger of the traveling vehicle.
